(19) United States
(12) Patent Application Publication
(10) Pub. No.: US 2010/0232988 A1
(43) Pub. Date: Sep. 16, 2010

(54) TETHERED AIRFOIL METHODS AND SYSTEMS

(75) Inventors: Robert Creighton, Madison, WI (US); John V. Mizzi, Poughkeepsie, NY (US)

Correspondence Address: Casimir Jones, S.C., 2275 DEMING WAY, SUITE 310, MIDDLETON, WI, 53562, US

(73) Assignee: WINDLIFT, LLC, Durham, NC (US)

(21) Appl. No.: 12/300,577

(22) PCT Filed: May 14, 2007
(86) PCT No.: PCT/US07/11498

§ 371 Date: Nov. 10, 2009

Related U.S. Application Data
(60) Provisional application No. 60/800,250, filed on May 12, 2006.

(51) Int. Cl. F04B 17/02; F03B 17/02

(52) U.S. Cl. 417/334; 60/495; 60/496

(57) ABSTRACT

The present invention relates to methods and compositions for power generation using a tethered airfoil. In particular, the present invention provides a cost effective, environmentally friendly alternative to generate power for the oil, water, and electric industries or any other application where power is desired.

### FIELD OF THE INVENTION

The present invention relates to methods and systems for power generation using a tethered airfoil. In particular, the present invention provides a cost effective, environmentally friendly alternative to generate power for the oil, water, and electric industries or any other application where power is desired.

### BACKGROUND OF THE INVENTION

In the United States today, the free flowing days of the oil era are gone. The remaining oil to be pumped doesn't come easy, and requires powerful pumps to be brought to the surface. These pumps consume increasing amounts of power for dwindling returns of oil. Over 400,000 Unites States oil wells pump less than 10 barrels of oil per day, at an average energy cost of $36,000 per year. Many pumps are no longer active because they do not generate a profit or only become active if the price of oil increases substantially. For every active field it will eventually cost more to pump the oil, maintain the equipment, pay employees and ship the oil to refineries than can be recovered at market. For many mature, declining fields there will soon be no profitable way to continue production.

All energy used at every stage of the production process, including all energy consumed by the employees of the energy supply chain (e.g., exploration, production, refining, transportation, and marketing) must be considered to understand the severe threat oil depletion has in the modern oil economy. This kind of analysis establishes the “energy embodiment” of all products and services in a modern economy. Because oil supplies over 38% of the total energy in the world economy for most products and services, the “oil embodiment” of those items is also a consideration. Consequently, oil products themselves have an “energy embodiment”. In the past this “energy embodiment” was small as oil flowed from the ground freely. Today, energy input is required to pump the oil from the ground. In 1910, every barrel of oil equivalent input would yield at least 10 barrels of oil as output. Today, the picture is much different; in the United States today for every barrel of oil equivalent energy input only approximately two barrels of oil are recovered.

Currently, the Energy Return on Energy Invested (EROEI) is the ratio that is considered when comparing energy producing systems. In order to calculate this ratio, components such as energy source quality and the energy density of a substance are taked into consideration. For example, one gram of fat provides 38.9 kJ of energy, one gram of sugar provides 17.2 kJ of energy, and one gram of 2,4,6-trinitrotoluene (TNT) provides 4.2 kJ of energy. The oil-derived product gasoline is one of the highest quality chemical energy sources available to humanity, in that one gram of gasoline provides 47.9 kJ of energy.

Energy Return on Energy Invested is not the whole story. Different machines are more efficient at extracting chemical energy for mechanical work. Currently the internal combustion engine is able to convert approximately 32% of the chemical energy in gasoline into mechanical work, the rest being lost to heat. Humans are about 5% efficient at converting chemical energy into mechanical work.

Electric motors are much more efficient, converting around 90% of electricity into mechanical work. However, electricity cannot be efficiently stored or transported. The infrastructure needed to supply and maintain a continuous supply of electricity is very expensive. To extend the current electrical grid can cost over $20,000 per mile. Electricity is also lost in transmission. Currently, the US loses approximately 7.2% of generated electrical power in transmission. In rural and wilderness areas this transmission loss, physical infrastructure, and maintenance costs adds significant cost to the total cost. That is why rural electricity is often subsidized by federal, state, and municipal governments, either directly or by requiring power companies to supply rural power in order to compete in lucrative urban markets.

Historically, energy inputs into the economy were not considered by economists because they were only about 5% of the equation. This is reflected in the current inflation statistics that only consider core inflation, excluding energy and food prices because of their volatility.

What is needed are new technologies that will pump the oil out of these mature wells in an economical manner utilizing lower quality energy sources, thereby increasing the useable lifespan of mature fields and their contribution to Unites States oil production. Likewise, alternative sources of energy for generating electricity and pumping water find use across many other applications.

### SUMMARY OF THE INVENTION

The present invention relates to methods and systems for power generation using a tethered airfoil. In particular, the present invention provides a cost effective, environmentally friendly alternative to generate power for the oil, water, and electric industries or any other application where power is desired.

The systems and methods of the present invention provide a tethered airfoil or kite generator, in some embodiments a buoyant tethered airfoil generator (BTAG), that is a wind driven power generation system. In some embodiments, the system is portable and easy to move from one location to another. In some embodiments, the system comprises a buoyant airfoil that is filled with a lighter than air gas (e.g., helium, hydrogen, etc.), a base station, and a tethering system which attaches the airfoil to the ground station where the motive force of the wind is converted into energy for pumping (i.e. work). The tethered airfoil or kite system utilizes the lift generated by wind flowing over or under the airfoil or kite to provide a pulling force through the tether to the ground station. In pumping operations, the mechanism of operation provides superior efficiency over solar cells and wind turbines, as the system of the present invention is not dependent on solar radiation and can access wind at higher altitudes (e.g., 500 feet and substantially higher above the earth) where wind speeds are consistently faster and less turbulent than winds available to wind turbine technology. For example, the airfoil or kite design is designed to maximize internal volume (and subsequent lift generated by the buoyant gas in the case of an airfoil), while maximizing the lift coefficients relative to the drag from both frictional and attack angle drag coefficients. This is achieved by maintaining laminar flow across the airfoil, minimizing turbulence.

The systems and methods of the present invention find use in any application where energy generation is desired. To illustrate certain features of the present invention, the invention is described below in the context of the oil industry. It should be understood that this is one exemplary embodiment of the invention and that the present invention is not limited to this particular embodiment. For example, the present invention finds use for commercial/industrial/and municipal power generation (e.g., electrical generation, water pumping and treatment facilities, irrigation needs, etc.). As well, the present invention finds use for domestic/residential power generation, for example to the point where a homeowner can partially or completely go off the existing power grid and become self-sufficient in terms of energy needs. A wide variety of other uses will be understood by skilled artisans.

In some preferred embodiments, the system of the present invention is portable, offering a large advantage over wind systems that require towers that are not easily movable, and are very expensive to erect and maintain. Only the base station equipment would be abandoned when transferring the airfoil and tether to a new location, although in some embodiments the base station is also portable. Wind tower systems, on the other hand, require a large capital investment in wind towers (over $1 million investment per Mega Watt of wind) and electrical utility installations (e.g., at remote oil stations).

With respect to the oil industry, the earth's petroleum resources will never be fully extracted, for the simple reason that at some point it becomes too difficult, too expensive and too damaging to the environment to continue extraction. This is the case for individual wells in addition to the world at large. When an oil well is initially tapped, the oil typically flows naturally from the ground due to the underground water and gas pressure built up over millions of years as the oil was formed. When the oil flows naturally in this way it is known as “natural lift.” As the oil is released, so is the pressure, and eventually the well ceases to produce oil on its own. At this point it becomes necessary to provide “artificial lift” to bring the oil to the surface. Pumps powered by gas or electricity commonly provide artificial lift.

When oil is extracted by pumping, it is known as “primary” recovery. Utilizing current technology only one-third to one-half of the oil in the reservoir is classified as recoverable. Oil wells typically reach their maximum productivity in barrels per day when roughly half the recoverable oil has been extracted. From that point on the well begins a steady, irreversible decline to lower yields. As oil wells are depleted it is frequently insufficient to merely provide artificial lift. At this point, well operators can employ secondary methods such as flooding the well with water, or even tertiary methods which are intended to improve the flow characteristics of the oil itself. These methods demonstrate the lengths to which well operators will go to extend the life of aging wells.

The United States is the most mature oil-producing nation on the planet. More oil has been extracted in the United States than from any other nation in the world, with a total of 180 billion barrels between 1918 and 1999. As a result, the United States has a large number of mature wells that have been pumped, coaxed and cajoled out of their recoverable oil. These wells are known as stripper wells.

There are around 391,000 operating stripper wells in America today, and over 78% of US wells are classified as marginal stripper wells. These wells provide 900 thousand barrels of oil per day, or 15% of the United States total oil production. Stripper wells produce less than 10 barrels of oil per day, along with a large quantity of brine. As the wells age the percentage of brine in the oil flow increases, requiring greater energy inputs to pump an equivalent amount of oil. In the decade from 1994-2003, over 142,000 marginal oil wells were abandoned in the United States. These wells were not dry; it was simply not economically feasible to continue running them with the low oil volume. The primary reason of economic infeasibility is the cost of the energy required to power the wells. All the other costs of those wells are sunk costs and are not considered in net present value calculations. Stripper wells run on motor driven pumps thereby consuming gas, oil, or electricity. As the price of fuel (e.g. electricity, diesel, natural gas) for the well's motors, plus transportation and maintenance costs of the well exceeds the value of the extracted oil, the well is shut down, orphaning the oil that remains underground. As oil prices increase, some of these wells are brought back online. Unfortunately, after a well sits idle for extended periods of time sediments clog the well making it very expensive to restart an idle well.

The demand for alternative energy sources is growing more each day as the population continues to use up most of the world's cheaply available hydrocarbon energy sources. North America is the world's second largest producer of oil, with the United States producing 60% of the total North American output, followed by Canada and Mexico. Geographically, there are oil wells scattered throughout the United States. The largest oil producing states or regions includes Texas, Alaska, California, and offshore production posts. However, there are stripper wells located throughout the Midwest, Northeast and Mountain areas of the United States. Marginal stripper wells tend to be more common in older well states, such as Oklahoma, Pennsylvania, and Texas.

The methods and systems of the present invention provide a low variable cost alternative for powering these wells which allows them to be re-opened where closed, operated longer, produce more oil, and reduce the well operators sensitivity to diesel, natural gas, and electricity prices. Additionally, the major source of pollution in active oil production areas is ground-water contamination by decaying wells that have not been properly sealed. Texas alone spends $6 million/year plugging contaminated wells. By extending the life spans of older wells the present invention reduces ground water pollution, and provides financial resources to finish plugging abandoned wells.

Therefore, the present invention does not require expensive equipment for power generation, it provides for direct (or indirect, if desired) drive to pumps thereby increasing pumping efficiency, it is portable, it provides a more environmentally friendly alternative to existing pumping systems, and it is more cost effective than existing systems for oil pumping.

For example, the present invention provides a system for generating power comprising an airfoil filled with a lighter than air gas, a tether attached to said airfoil, a counterbalancing force attached to said tether, and a means for generating power whereby the lift from wind flowing across an airfoil creates a differential tension in the tether which is translated by the mechanical assembly associated with the counterbalancing force into mechanical energy for generating power. In some embodiments, the system further comprises a beam type artificial lift oil well for pumping oil. In some embodiments, the lighter than air gas in said airfoil is selected from a group consisting of hydrogen, helium, and neon. In some embodiments, the airfoil of said system can be wing shaped, wherein the leading edge can be rounded or sharp and the trailing edge is tapered. In some embodiments, said wing-shaped airfoil can be further thicker at the leading edge compared to the trailing edge. In some embodiments, multiple systems are attached to said means for generating power. In some embodiments, the tether of said system further comprises a gas line for furnishing gas to the airfoil, a worm gear drive, and/or a sensor for adjusting said gas to said airfoil. In some embodiments, the system further comprises a lighting system located on said tether. In some embodiments, the tether is at least 300, more preferably at least 500 feet long. In some embodiments, the length is greater than 1000 feet (e.g., greater than 2000, 5000, 10,000 feet).

The present invention further provides a method of generating energy comprising attaching the system of the present invention to a means for generating energy, and activating that system to generate energy. For example, the present invention provides a low-cost method for generating electricity or power and pumping water using a kite system of the present invention.

The present invention further provides a method for invigorating an oil well comprising providing a buoyant tethered airfoil system, a beam type artificial lift oil well, attaching the airfoil system to the artificial lift oil well, and powering said artificial lift oil well causing oil to be pumped from the non-viable well, in some embodiments. In some embodiments, the method for invigorating an oil well further serves to reduce the energy required for pumping the oil as compared to a method in the absence of the airfoil system.

### DESCRIPTION OF THE FIGURES

FIG. 1 shows the airfoil and its associated wind powered attack angle controller, and tether design in an embodiment of the present invention.

FIG. 2 shows the counterbalancing force mechanism and power generation mechanism in the base station that is affected by the tension in the tether based on wind velocity in an embodiment of the present invention. Depending on the application, the counterbalancing force will be of a magnitude in the range greater than T₂ and less than T₃. T₂ and T₃ are constantly changing depending on wind velocity and the counterbalancing force is adjusted to an ideal magnitude for the wind velocity and current application.

FIG. 3A-C shows the airfoil/tether wind configurations; A) no wind, B) with wind and a small attack angle relative to the air stream C) with wind and a larger attack angle relative to the air stream. Lift and drag coefficients generated are dependent upon the attack angle; by increasing the attack angle the net lift of the airfoil is increased providing the motive force on the ground. Attack angles are variable and are adjusted to maximize the tension differential in the tether between position 2 and position 3, thereby maximizing the motive force available for work on the ground.

FIG. 4 shows the relationship between the attack angle of the airfoil and the tensile force on the tether that is translated into work available for power generation in embodiments of the present invention.

FIG. 5 shows exemplary airfoil designs.

FIG. 6 shows exemplary kite systems comprising a base station control system for steering a 4-line kite.

### DEFINITIONS

As used herein, the term “airfoil” refers to a kite or a lighter than air balloon. For the airfoil, the airfoil can take on any shape, but is preferentially shaped like a large wing or blade as seen in cross section. Specific shapes and configurations of airfoils of the present invention are described elsewhere herein. A kite as used herein refers to one or more flat surfaces of any shape and size capable of aerial ascent and descent due to windspeed and the like.

As used herein, the term “tether” refers to an attachment line (e.g., flexible attachment line) that connects the airfoil to a base station. In some embodiments of the present invention, the tether is made of a woven fiber core wherein is located a tube which supplies a gas to the attached airfoil.

As used herein, the term “attack angle” refers to the position of the airfoil relative to the prevailing air stream; the angle between the airfoil's chord line and the direction of airflow wind.

### DETAILED DESCRIPTION OF THE INVENTION

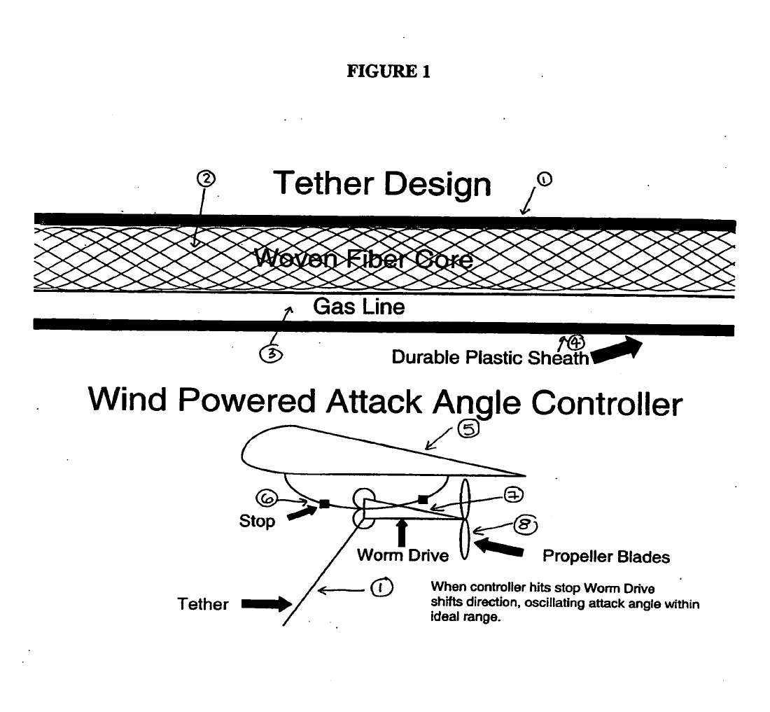

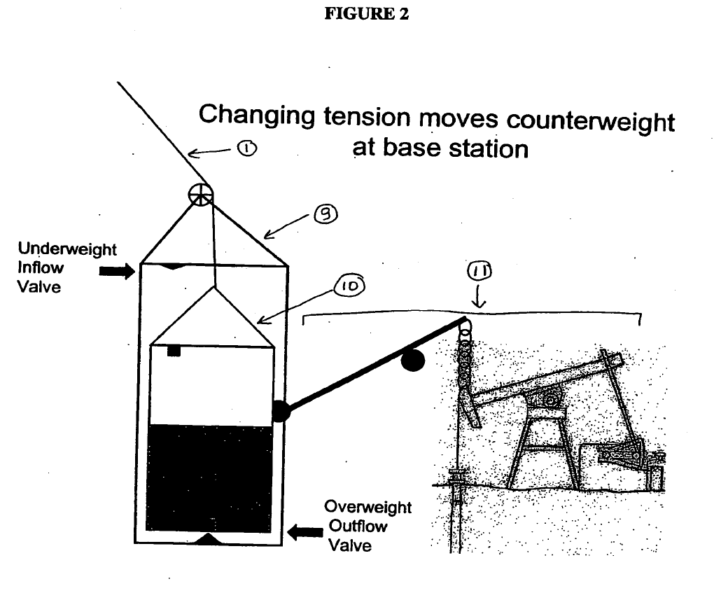

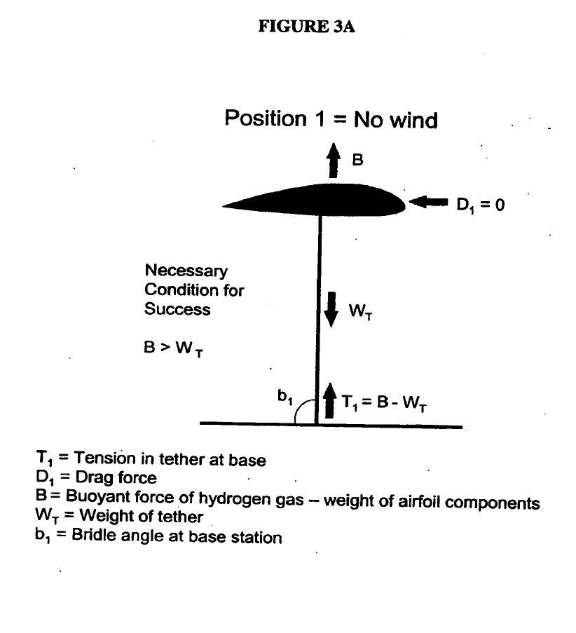

Certain embodiments of the present invention are described in more detail below. The present invention is not limited to these particular illustrative embodiments. Traditional oil pumping systems and energy generation systems require the use of a turbine, whereas the BTAG system is a direct drive system that does not require a turbine. An exemplary BTAG system of the invention is shown in FIGS. 1 and 2.

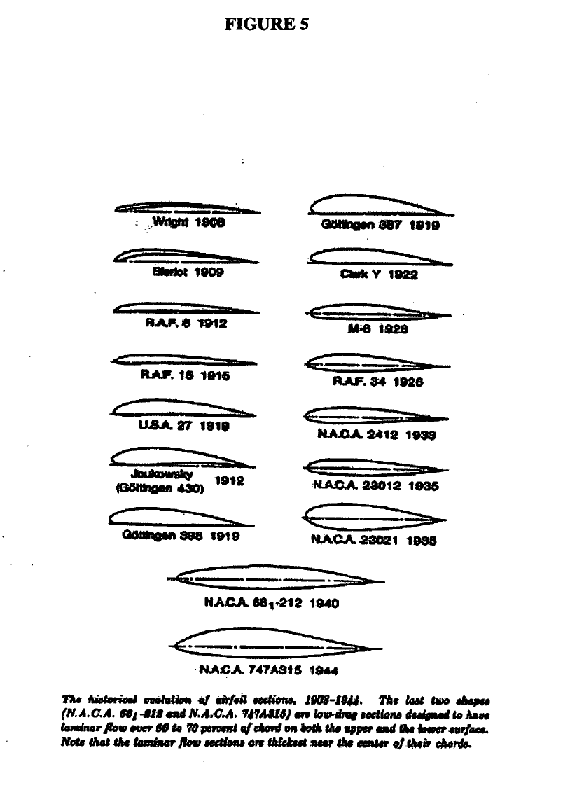

The following embodiments are not limited by the materials listed. Indeed, the materials listed are provided for exemplary purposes only, and those skilled in the art will recognize equally viable alternatives. Additionally, the airfoil is not limited by the dimensions of the airfoil, as all sizes of airfoils are contemplated. One skilled in the art would recognize size differences that would be optimal for varying conditions. FIG. 5 demonstrates different historical airfoil designs.

One embodiment of the present invention (FIGS. 1 and 2) comprises a lighter than air balloon, a tether (1), and a base station (9). In some embodiments, the lighter than air balloon is an airfoil (5) in the shape of a wing. The airfoil is not limited by size, indeed all dimensions of airfoils are contemplated. For example, the size of the airfoil required is dependent upon the wind velocity at the altitude of the airfoil, the location of the application, and the amount of work to be done at the site. The present invention is not limited to a particular mechanism. Indeed, an understanding of the mechanism is not necessary to practice the present invention. Nonetheless, it is contemplated that larger airfoils will generate more lift from a given wind velocity, and consequently more work. It is contemplated that larger airfoils further contain a larger volume of lighter than air gas providing more buoyancy to lift a longer tether under no wind conditions. In some embodiments, the airfoil envelope material is made from a relatively non-expandable material, wherein such material is capable of transferring the generated lift to the ground without energy lost to flutter, ripple, and warping over the airfoil surface. In some embodiments, the airfoil will have an internal structure made of, for example, carbon fiber, graphite, ceramic, aluminum, or other lightweight, and stiff materials maximizing the rigidity of the airfoil relative to weight and cost constraints. Those skilled in the art will be able to apply any number of internal airfoil structural designs that meet the requirements of the BTAG system.

In some embodiments, the wing-shaped airfoil is attached to a large pointed Zepellin shaped cylinder. In some embodiments, a system for controlling the relative orientation of the airfoil in the air stream (e.g., airfoil attack angle) affects the tension in the tether. It is contemplated that said system is controlled from the airfoil itself, the base station, or radio/electronic communication, for example.

In some embodiments, the airfoil further comprises a worm gear drive (7) that travels between stop locations (6) at the attachment point beneath the airfoil. For example, the worm gear drive changes the attachment point (e.g., bridle point), causing a net torque on the airfoil in relation to the center of weight, the center of pressure, and the attached tether. This torque generates the motive force that changes the attack angle of the airfoil relative to the airflow. In some embodiments, the worm drive further comprises propeller blades (8) that rotate based on wind speed thereby causing the worm drive to move between stop locations. In some embodiments, the present invention utilizes one airfoil per system.

In some embodiments, the base station contains electrical and/or mechanical apparatus to manipulate the orientation of the airfoil (e.g., attack angle) relative to the prevailing wind. For example, the orientation of the airfoil needed to maximize the prevailing wind energy is communicated electronically through the tether, by radio waves, or by mechanical systems thereby matching changes in the airfoil attack angle to the power requirements at the base station. In some embodiments, this communication helps coordinate the movements of the counterbalancing system with the attack angle of the airfoil, improving efficiency under varying wind conditions. In some embodiments, the base station additionally contains mechanical systems to rotate either the base station or the tether guide system as the wind direction changes, ensuring that the tether does not become twisted and friction in the tether guide system is minimized. In some embodiments, the counterbalancing force generated by W_{c} is provided by an air driven hydraulic pump and accumulator, for example by moving a counterweight along a lever arm, or various spring assemblies.

In one embodiment of the present invention, the airfoil (the kite) is in the shape of a wing or blade (for example, see FIG. 5). In some embodiments, the airfoil comprises a rounded leading edge and a sharp tapered trailing edge. In some embodiments, the thickness at the leading edge of the airfoil is greater than the thickness at the trailing edge. In some embodiments, the airfoil exhibits camber or curvature. In some embodiments, camber is high. In some embodiments, camber is low. In some embodiments, the airfoil is more angular in shape and comprises a sharp leading edge. Examples of airfoil designs and strategies can be found in, for example, Hansen, J R, 1987, NASA SP-4305; Wortman, F X, 1961, Boundary Layer and Flow Control, Vol. 2, G V Lachmann, Ed., Pergamon Press, pp. 748-770; McGhee R J et al., 1979, NASA TM-78709; Eppler, R, 1990, Airfoil Design and Data, Springer-Verlag; Maughmer M D et al., 1989, J. Aircr. 26:148-153, all incorporated herein in their entireties.

In one embodiment, the airfoil is attached to a large Zepellin-like pointed cylinder. In some embodiments, the attack angle of a Zepellin-like pointed cylinder is achieved by either moving the attachment point or rotating the attached airfoils relative to the Zeppelin structure.

In one embodiment, the material covering the airfoil is a polyester film. For example, the material utilized is designed to maintain a rigid, semi-rigid, or flexible envelope depending on the specific application. It is contemplated that the material utilized be both lightweight and be capable of minimizing the rate of gas transfer across the envelope. It is further contemplated that the material has enough stiffness to maintain airfoil shape relative to the internal structure of the airfoil. In some embodiments, the material utilized will minimize the drag generated by air friction as air flows across the airfoil. In some embodiments, the material utilized will be resistant to damage from solar ultraviolet radiation. In some embodiments, the envelope will contain an internal gas pressure greater than the surrounding atmosphere. In some embodiments, the envelope will contain an internal gas pressure equal to the surrounding atmosphere. In some embodiments, the airfoil contains multiple, smaller balloons thereby preventing complete loss of buoyancy in the event of damage to the airfoil covering. In some embodiments, the polyester film is a biaxially-oriented polyethylene terephthalate polyester (boPET) film. Examples of a polyester film can be found in U.S. Pat. No. 4,059,667, incorporated herein in its entirety. In some embodiments, the material covering the airfoil is a synthetic fiber. In some embodiments, the synthetic fiber is a poly-paraphenylene terephthalamide or aramid derivative thereof. In some embodiments, the synthetic fiber is from the synthetic polymer family of materials, for example a thermoset polyurethane material. In some embodiments, thermoset polyurethane is an electron beam cross-linked thermoplastic polyurethane. In some embodiments, the synthetic fiber is an ultra high molecular weight polyethylene or a derivative thereof. Examples of synthetic fibers contemplated for use in the present invention can be found in U.S. Pat. Nos. 5,084,497, 4,408,020, 4,467,078, and 4,243,463, all incorporated herein in their entireties. However, the present invention is not limited in terms of materials used, and other suitable material covering for airfoils are contemplated and known to those skilled in the art.

In one embodiment, the present invention is used for pumping water. In some embodiments, the present invention is used to pump water to a reservoir that is used to drive hydroplants. In some embodiments, the present invention is used to pump water for coal, nuclear, and gas fired plants. In some embodiments, the present invention is used to pump water for water treatment and/or disposal facilities. In some embodiments, the present invention is used to pump water up an altitudinal grade, or from water abundant to water arid regions. In one embodiment, the present invention is used to drive a flywheel to provide constant electrical power. In one embodiment, the present invention is used to provide power for lifting objects for mining or transportation industries. In some embodiments, the present invention is used to provide power for driving a grinding apparatus for material processing (e.g., grain processing, materials shredding, etc.). In some embodiments, the present invention is used to pump oil along pipelines. In some embodiments, the present invention is used to pump natural gas along pipelines. In some embodiments, the present invention is used to lift materials for construction purposes. In some embodiments, the present invention is to power energy needs in buildings (e.g., air circulation, elevators, electricity, etc). In some embodiments, the present invention is used to power pumps for air-conditioning and/or refrigeration systems. In some embodiments, the present invention is used on ships to provide power for ship related energy needs (e.g., heating, cooling, propulsion, etc.). In some embodiments, the present invention is used to power off-shore oil platforms. In some embodiments, the present invention is used to power pile driving systems. In some embodiments, the present invention is used to power space crafts, such that deployment of the present invention harvests solar winds thereby providing power in an extraterrestrial environment.

In one embodiment the tether (1) comprises a flexible material outer shell (4), a woven core (2), and a gas line (3). In some embodiments, the flexible material is a durable plastic. For example, it is contemplated that the flexible material be resistant to ultraviolet light, be friction resistant, retain minimal shape memory, and be durable. In some embodiments, the tether contains a short segment near the base station which has a thicker outer shell resistant to frictional damage created by the tether guide system at the base station. In some embodiments, the outer shell surrounds a woven fiber core and a gas line adjacent to the woven fiber core. In some embodiments the gas line connects a gas source to the airfoil. For example, the gas line provides for constant gas pressure in the balloon. In some embodiments, the gas is a lighter than air gas (e.g., hydrogen, helium, neon). In some embodiments, the gas is preferably helium or hydrogen. In one embodiment the woven fiber core comprises one or more materials (e.g., Kevlar®, Spectra®, Vectra®, Zylon®, etc.). In one embodiment the tether connects the airfoil to the base station. In one embodiment, the tether additionally comprises a metallic wire or metallic wires capable of transmitting electrical power and/or control communications to the airfoil. In some embodiments, the base station (9) comprises a mechanism whereby tension from the tether is converted to mechanical energy. In some embodiments, the mechanism comprises a counterbalancing system (10). In some embodiments, the counterbalancing system consists of a reservoir that contains a liquid such as water, the level of which is adjustable to capture the maximal amount of wind-generated power for conversion to mechanical energy. In some embodiments the counterbalancing force is provided by an air driven hydraulic pump and accumulator, thereby moving a counterweight along a lever arm, or various adjustable spring assemblies. In some embodiments, the counterbalancing system is further attached to a beam type artificial lift oil well (11). In some embodiments, the artificial lift system uses hydraulics to provide the counterbalancing force, wherein the airfoil/tether are attached directly to the hydraulic system whereby the adjustable counterbalance in the hydraulics is used to offset the changes in tension of the BTAG system.

In some embodiments, the tether is longer than 300 feet, preferably 500 to 1000 ft long, more preferably greater than 1000 ft long. In some embodiments; the tether is over 5000 ft, over 10,000 ft, over 15,000 long.

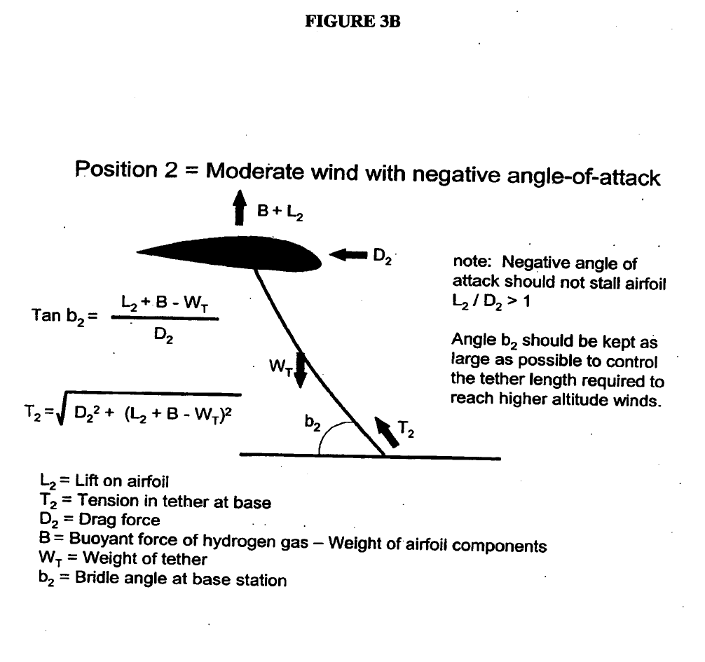

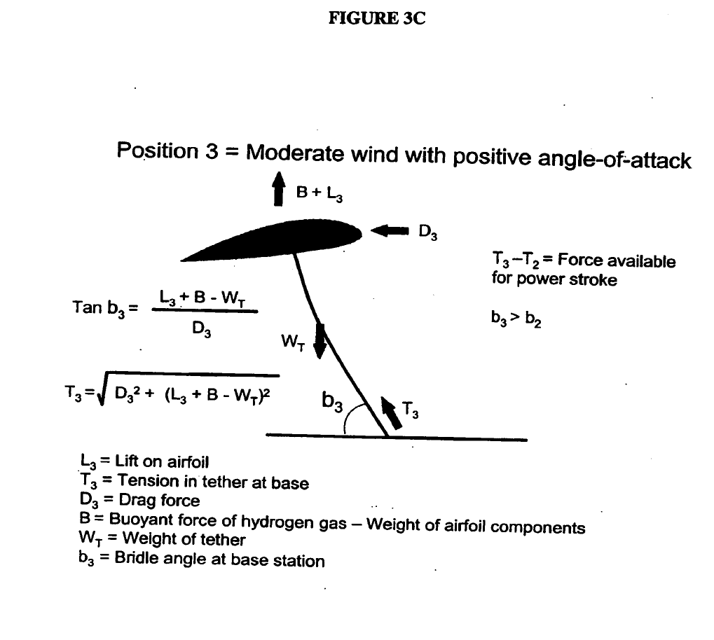

The airfoil (5) angle of attack to the prevailing wind stream is altered by a worm gear drive (7), which allows for the airfoil to oscillate its attack angle relative to the prevailing air stream (FIG. 1). The ideal attack angle changes depending on wind speed, airfoil design, and power requirements on the ground. The wind on the airfoil generates a variable lifting force in the tether (1) by oscillating the attack angle between position 2 and 3 (FIGS. 3B-3C). Through this action a differential force is generated that is translated through the tether to the base station (9) to power pumping operations. In the base station, the tether is attached to an adjustable counterbalancing system (10) (e.g., a reservoir containing a liquid, an air driven hydraulic pump and accumulator, a counterweight moveable along a lever arm, or various spring assemblies), and the changing tension in the tether moves the counterweight or equivalent mechanical assembly up and down (FIG. 2). The amount of opposing force provided by the counterbalance system (W_{c}) is adjustable to match the wind velocity thereby maximizing the efficiency of the system and creating the most power from the wind as possible. Where applied to oil pumping, the counterbalancing system is further attached to an artificial lift system for oil pumping operations (11). As the counterbalancing system moves up and down because of the changing tension in the tether due to the oscillating attack angle of the airfoil, the beam attached to the counterweight lifts or drops, lifting the attached rod, and thereby causing the oil to be pumped out of the well.

In order for power generation to occur, there should first be tension in the tether. In a windless scenario, the tension is the result of the net buoyancy of the airfoil, B, minus the weight of the tether, W_{T} (FIG. 3A, T₁=B−W_{T}), since the drag force (force of the wind on the airfoil) is essentially zero (D₁=0). Therefore, in a windless situation, the tension in the tether at the base station, T₁, is small. This type of scenario is experienced at lower altitudes during launching where wind velocity is non-existent. However, at higher altitudes where higher wind speeds are sustained, such as where the BTAG system would preferably be deployed, the tension in the tether necessarily changes as lift forces, L, on the airfoil increase causing increased tension in the tether, T (FIGS. 3B-C). Drag on the system is minimized by the use of the attack angle control mechanism (FIG. 1).

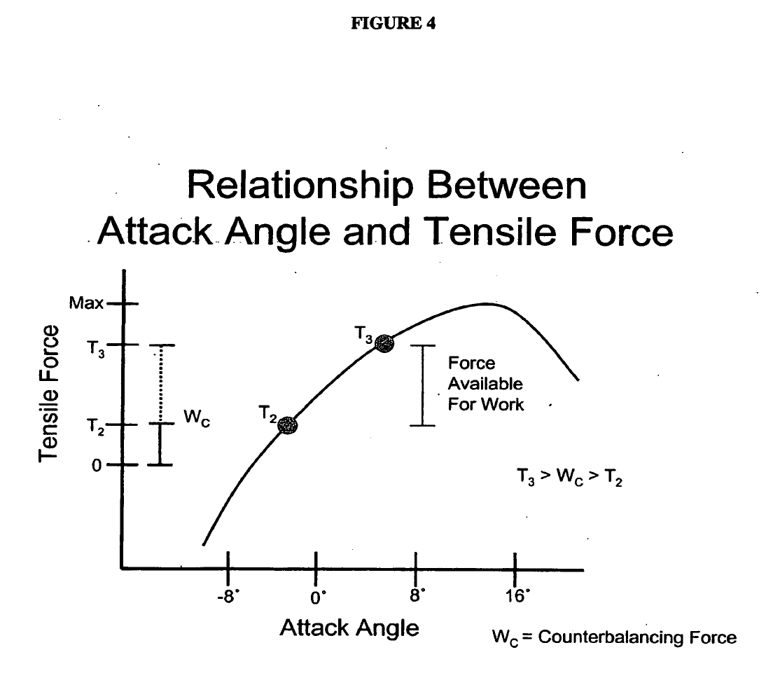

The wind powered worm-drive system featured in FIG. 1 is only one potential control mechanism for the attack angle. It is contemplated that any mechanical system capable of altering the attack angle can be used to power an electrical, wind, solar, fuel cell, or internal combustion power source. For example, the attack angle can be controlled by rotating the airfoil relative to an attached Zeppelin-like cylinder, or changing the attachment point or other relative forces through tether webbing at multiple attachment points. The potential methods for affecting the attack angle are widely varied and skilled practitioners of the art will appreciate the most effective method for specific applications. The attack angle is not the only method that can be used to affect the lift generated by the wing. For example, it is contemplated that any method that increases turbulence or causes the wing to stall or spoil without generating excess drag would fulfill the same function as the attack angle control mechanism. As such, for every airfoil design, the lift and drag is expressed as a function of wind speed and the angle of attack of the airfoil. As the attack angle oscillates between positions 2 and 3 (FIGS. 3B-3C) different tensions in the tether are realized (T₂ and T₃). The counterbalancing force (W_{C}) is kept in the range greater than T₂ and less than T₃. As the wind speed changes both T₂ and T₃ change and the counterbalancing force is adjusted to within the range between T₂ and T₃. Depending on the application, the counterbalancing force will be closer to T₂ (e.g., lifting applications such as rod-lift pumping), closer to T₃ (e.g., pushing applications such as pile driving), or the average of T₂ and T₃ (e.g., equivalent force required for lifting and pushing such as driving a generator). The difference in tensile force between positions 2 and 3 (T₃−T₂) is subsequently available at the base station for power generation (e.g., work), and the counterbalancing force W_{c} is kept within a range between T₂ and T₃ depending on the application (FIG. 4).

In one embodiment, the present invention further comprises a sensor system for sensing the gas levels in the airfoil. In some embodiments, the airfoil contains multiple, independent balloons filled with lighter than air gas whose internal pressure can be adjusted independently. The multiple, independent balloons may also contain independent sensors and valves allowing them to maintain independent internal pressure. The present invention is not limited to a particular mechanism. Indeed, an understanding of the mechanism is not necessary to practice the present invention. Nonetheless, we contemplate that this fail-safe mechanism would prevent the airfoil from collapsing or falling from the sky if the airfoil envelope is ruptured. It is additionally contemplated that the pressure in the multiple, independent balloons can be adjusted to maintain the airfoil in a horizontal orientation perpendicular to the airflow and the ground according to established lighter-than-air machine control protocols. In some embodiments, the sensor system relays information to the gas source that releases more gas to the airfoil to maintain maximum buoyancy and efficiency of use. In some embodiments, the present invention further comprises a sensor system that allows the airfoil to maintain as close to a 90° bridle angle to the base station as possible for maximum system efficiency. In some embodiments, the airfoil and tether are illuminated. In some embodiments, the lighting is non-stop (e.g., the system is lit all the time, 24 hours a day, 7 days a week). In some embodiments, the lighting occurs in response to a sensor system. For example, the sensor is triggered under low light conditions and the lights go on in response to the trigger mechanism, thereby lighting the airfoil and tether under low and no light conditions. In some embodiments, the airfoil contains a radio beacon that actively or passively (e.g., Radio Frequency Identification device) transmits its location to passing aircraft alerting them to maintain a safe distance from the BTAG system. In some embodiments, lighting is triggered upon a signal indicating the proximity of an object (e.g., an aircraft). In some embodiments, the airfoil is deployed at least 300 feet above the earth, preferably 500 to 1000 ft above the earth, more preferably greater than 1000 ft above the earth. In some embodiments, the airfoil is deployed at very high altitudes (e.g., over 5000 ft, over 10,000 ft, over 15,000 feet above the earth).

In one embodiment the tether further comprises a safety mechanism such that in high winds (e.g., gusts) the BTAG will return to a neutral lift position. In one embodiment the BTAG system is further retractable to a locked position on a reinforced mooring mast protecting the airfoil in severe atmospheric conditions (e.g., lightening, thunderstorms, sustained potentially damaging high winds, etc.). In some embodiments the tether further comprises a balloon located between the gas source and the airfoil that has the ability to accept gas from the airfoil. For example, as the gas in the airfoil heats due to atmospheric conditions (e.g., diurnal heating, solar radiation) it expands, and the balloon thereby accepts the overflow gas and relieves the pressure in the airfoil.

In some embodiments, the outer surface of the airfoil is colored with an easy to observe material. In some embodiments, aesthetic coloring or markings are used. In some embodiments, the airfoil is camouflaged against the sky background reducing visual pollution. In some embodiments, the airfoil envelope is a translucent material. In some embodiments, advertising or other images or text or provided such that they are viewable from the ground or from the air. In some embodiments, an imaging system is provided on the outside of the airfoil or on a separate component attached to the airfoil or tether that permits information or images to be provided, including changing images (e.g., weather information, time of day, changing advertising, etc.).

In one embodiment the present invention provides methods and systems for an oil well where artificial lift is required to bring oil to the surface. In some embodiments the present invention provides methods and systems for re-invigorating an oil well exhibiting decreased oil production. In some embodiments, the present invention provides methods and systems for bringing a previously abandoned oil well into production (e.g., non-viable oil well).

In some embodiments, the methods and compositions of the present invention provide for the pumping of subterranean water. In some embodiments, the present invention provides materials and systems for pumping water for irrigation purposes (e.g., farm irrigation, livestock irrigation, terraforming). In some embodiments, the present invention is used by public works departments (e.g., municipal, state, federal) for pumping water for community needs. In some embodiments, the present invention can be further used by public works departments to generate electricity.

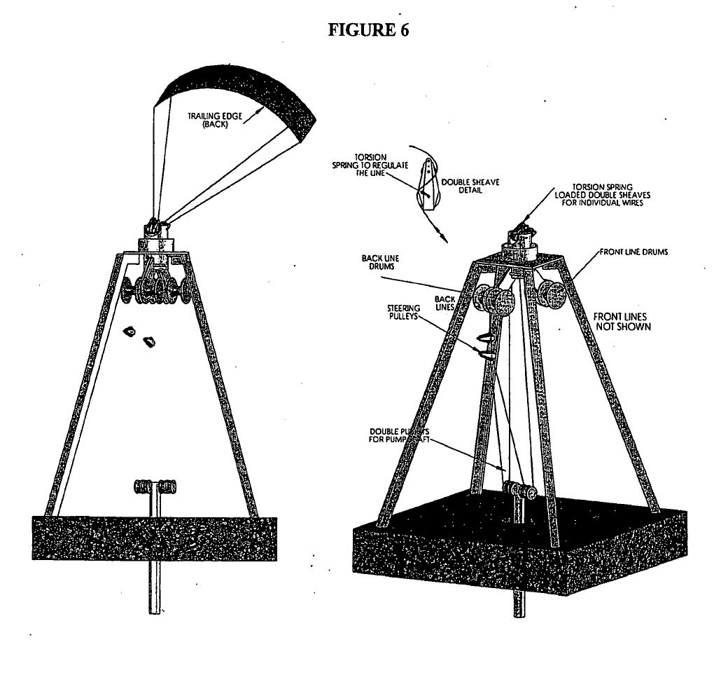

In some embodiments, the present invention provides private citizens, towns, villages, etc. a cost-effective system to generate energy electricity, power for pumping water and the like. FIG. 6 shows an exemplary embodiment of such a system. A system is controlled using, for example, 2, 3, 5, or greater line kites by adding more line paths. The two back lines are tied into a steering mechanism. The steering mechanism changes the relative tension on the back lines, altering the airfoil or kite shape, thereby causing the kite to change direction. This allows the control system, either through manual or automatic operation, to steer the kite in a pattern that maximizes the continuous line tension. The tension in the lines is transferred through the “pump pulley” to the pumping mechanism. A feedback mechanism connects the pump cycle to either the front lines or the rear lines. In the case of the front lines, as the pump nears the upper limit of its stroke the front lines are pulled in, thereby reducing the attack angle of the airfoil, depowering the kite, decreasing line tension, and allowing the counterbalancing force to reset the pump. The attack angle is held at the reduced angle until the pump is reset, whereby the front lines are let out to the optimal length for creating the maximum line tension. If the pump feedback mechanism is connected to the back lines, the back lines are let-out as the pump nears the upper limit of its stroke, thereby reducing the attack angle of the airfoil, depowering the kite, decreasing line tension, and allowing the counterbalancing force to reset the pump. The attack angle is held at the reduced angle until the pump is reset, whereby the back lines are reeled in to the optimal length for creating the maximum line tension, continuing the cycle. The four winch drums, as exemplified in FIG. 6, comprise safety mechanisms that protect the system from damage during high winds, and automatically retrieves the kite during low winds. The winch drums comprise, for example, springs, pneumatics, or counterweights which allow a series of mechanisms which automatically set a minimum and maximum tension in each of the lines. For example, when these limits are reached the system responds by letting out line, or reeling in line as necessary. The drag-release mechanism enabled when the lines exceed maximum tension are set to release more line from the rear lines of the kite. This effectively reduces the attack-angle of the airfoil, de-powering the kite, and decreasing line tension. This system automatically resets itself once the wind speed returns to safe operating levels. Ongoing costs to power water systems with electric and diesel engines can be a great drain to meager resources on a community or personal level. As the price of energy increases, farmers working marginally productive land can no longer afford to irrigate their crops, and villages can no longer afford to access clean drinking water. Currently, some of the energy needs are met by manual pumps, however human power is limited and as such farmers and communities rely on diesel powered pumps which contribute greatly to pollution and increase the price pressure on dwindling petroleum reserves. As such, systems of the present invention provide cost-effective sustainable power source in the form of wind power to generate energy or power, for example, for generating electricity and/or pumping water. Systems of the present invention are further operable by unskilled labor; as such they are within reach of an average farmer or community.

Further, the compositions and methods of the present invention can be used to generate electricity, thereby allowing the private citizen to exit or reduce the need for the existing power grid.

In some embodiments, the present invention comprises a base station control system for steering a 4-line kite. The same system can also comprise, for example, 2, 3, 5, or greater line kites by adding more line paths. In some embodiments, the two back lines are tied into a steering mechanism. The steering mechanism changes the relative tension on the back lines, altering the airfoil shape, thereby causing the kite to change direction. This allows the control system, for example through manual or automatic operation, to steer the kite in a pattern that maximizes the continuous line tension. The tension in the lines is transferred through the “pump pulley” to the pumping mechanism. Further, a feedback mechanism connects the pump cycle to either the front lines or the rear lines. In the case of the front lines, as the pump nears the upper limit of its stroke the front lines are pulled in. This serves to reduce, for example, the attack angle of the airfoil thereby de-powering the kite, decreasing line tension, and allowing the counterbalancing force to reset the pump. The attack angle is held at the reduced angle until the pump is reset, whereby the front lines are let out to the optimal length for creating the maximum line tension. If the pump feedback mechanism is connected to the back lines, the back lines are let-out as the pump nears the upper limit of its stroke. This reduces the attack angle of the airfoil thereby de-powering the kite, decreasing line tension, and allowing the counterbalancing force to reset the pump. The attack angle is held at the reduced angle until the pump is reset, whereby the back lines are reeled in to the optimal length for creating the maximum line tension, continuing the cycle. The 4 winch drums (FIG. 7) comprise safety mechanisms which, for example, protect the system from damage during high winds, and automatically retrieves the kite during low winds. The winch drums comprise springs, pneumatics, or counterweights allowing a series of mechanisms which automatically set a minimum and maximum tension in each of the lines. For example, when these limits are reached the system responds by letting out line, or reeling in line as necessary. The drag-release mechanism enacted when the lines exceed maximum tension are set to release more line from the rear lines of the kite. This reduces the attack-angle of the airfoil thereby de-powering the kite and decreasing line tension. In some embodiments, the system automatically resets itself once the wind speed returns to safe operating levels.

The present invention can also be used in conjunction with other technologies. For example, power generation technologies such as solar panels, geothermal energy, hydrothermal energy, nuclear energy, fossil fuels (e.g., coal, methane, petroleum, etc.) can be combined with the methods and systems of the present invention.

In one embodiment, the systems and methods of the present invention are incorporated into business strategies for the invigoration of non-viable wells. In some embodiments, the business strategies involve the transport of the BTAG system from well to well or implementation of multiple systems on otherwise economically less relevant wells, thereby reducing costs and maximizing profits of the once non-viable oil wells.

In some embodiments, the present invention provides for the installation of a control station for the airfoil, or kite, system for harvesting wind power. Such installations include, but are not limited to, a control station wherein the harvested wind power is used for pumping water, generating electricity, and the like. In some embodiments, a control station is installed in an aquatic environment, such as offshore in a lake, sea or ocean. In some embodiments, a control station is installed on land. Installation of a control station includes, but is not limited to, the installation of a structure within which resides a pump, pump shaft, pulleys, torsion springs, lines, tethers, drums and the like necessary to operate a system of the present invention. Installation of a control station also includes the installation of aerial structures that are a part of the operating system and are in direct communication with structures inside a control station, such as the tethers and airfoil or kite, and torsion springs. Exemplary sketches of control stations of the present invention are found in FIG. 6. The control station is installed and affixed to a stationary structure, for example an anchored platform if installed in an aqueous environment, or to the ground or other terrestrial substrate if installed on land. The control station can be in the form of an open air structure, such as that depicted in the sketch in FIG. 6, or it can be a more traditional structure comprising four or more walls, a roof wherein is maintained the communication between inside and outside aspects of the present invention, a floor, access doors, etc. Mechanical means for converting the energy generated by the system to, for example, electrical energy or the operation of a pump for pumping water, are found in the control station, under the control station, or in proximity to the control station. The control station further comprises a steering system for the tethered airfoil or kite wherein the manual operator or automated control system is isolated from the high tensions created in the lines. Further, the control station is such that easy access for maintenance, repairs, and operation by operators is maintained.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the art are intended to be within the scope of the following claims.

We claim:

1. A system for generating power comprising:
a) an airfoil filled with a lighter than air gas,
b) a tether attached to said airfoil,
c) a counterbalancing force attached to said tether, and
d) a means for generating power whereby wind lifts the airfoil thereby causing tension in the tether which is translated by the counterbalancing force into mechanical energy for generating power.

2. The system of claim 1, wherein said means for generating power is a beam type artificial lift oil well.

3. The system of claim 1, wherein said tether further comprises a gas line for supplying gas to said airfoil.

4. The system of claim 1, wherein said lighter than air gas is selected from the group consisting of helium, hydrogen, and neon.

5. The system of claim 1, wherein said tether attached to said airfoil further comprises a worm gear drive.

6. The system of claim 3, wherein said tether further comprises a sensor for adjusting the supply of said gas to said airfoil.

7. The system of claim 4, wherein said tether further comprises a lighting system.

8. The system of claim 1, wherein said tether is at least 300 feet long.

9. The system of claim 1, wherein said tether is at least 500 feet long.

10. The system of claim 1, wherein said airfoil comprises a wing shape.

11. The system of claim 10, wherein said wing shaped airfoil comprises a rounded leading edge and a tapered trailing edge wherein said leading edge is thicker than said trailing edge.

12. The system of claim 10, wherein said wing shaped airfoil comprises a sharp leading edge and a tapered trailing edge wherein said leading edge is thicker than said trailing edge.

13. The system of claim 1 further comprising multiple airfoils and tethers attached to said means for power generating.

14. The system of claim 2, wherein said beam type artificial lift oil well is part of an oil well pumping system.

15. A method of generating energy comprising:
a) providing the system of claim 1,
b) attaching said system from claim 1 to a means for generating energy, and
c) activating said system to generate energy.

16. A method for invigorating an oil well comprising:
a) providing a buoyant tethered airfoil system of claim 1,
b) providing a beam type artificial lift oil well,
c) attaching said buoyant tethered airfoil system to said beam type artificial lift oil well, and
d) using said attached buoyant tethered airfoil system to power the artificial lift oil well thereby causing oil to be pumped out of the non-viable oil well.

17. The method of claim 8, wherein said pumping of said oil from said non-viable oil reduces the energy required for pumping the oil as compared to the method in the absence of the airfoil system.

18. A method for steering a tethered airfoil that isolates the manual operator or automated control system from the high tensions created in the lines.

19. A method for connecting the tethered airfoil control mechanism to the pump cycle comprising attaching said tethered airfoil control mechanism to said pump cycle wherein when the pump reaches the upper limit of a cycle the attack-angle of the airfoil is reduced and wherein at the lower limit of the cycle the airfoil angle is not reduced.

20. A method for protecting the control station, tethers, and airfoil from damage in high-wind and low-wind conditions comprising providing a drag-release mechanism wherein said tethers are automatically reeled out in high-wind conditions and reeled in under low-wind conditions thereby protecting the control station, tethers, and airfoil from damage in high and low wind conditions.

21. The method of claim 20, wherein said drag-release mechanism reduces the attack-angle of the airfoil thereby reducing tension in the tethers under high-wind conditions.

22. A method for installing a control station system for harvesting wind power comprising:
a) providing a stationary platform,
b) affixing a control station to said platform, wherein is located mechanical means comprising a pump, pump shaft, pulleys, torsion springs, lines, tethers, drums, and
c) affixing a kite to said mechanical means thereby installing a control station system for harvesting wind power.

23. A system as shown in FIG. 6.

24. A system for pumping water using the system of claim 23.
